(19) United States
(12) Patent Application Publication
(10) Pub. No.: US 2003/0079761 A1
(43) Pub. Date: May 1, 2003

(54) Apparatus and method for washing and processing food

(76) Inventor: Sandra S. Rich, Decatur, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/305,280

(22) Filed: Nov. 26, 2002

Related U.S. Application Data
(63) Continuation-in-part of application No. 09/659,236, filed on Sep. 11, 2000, now Pat. No. 6,508,257.
(60) Provisional application No. 60/153,555, filed on Sep. 13, 1999.

(51) Int. Cl. B08B 9/20

(52) U.S. Cl. 134/25.3

(57) ABSTRACT

A hands-free, electrically operated food washing and preparation device having a fluid dispenser, such as a reservoir, a wash compartment, a motor-driven agitator, a removable food basket, and a drain for removing soiled fluid from the device. Also provided is a variety of adaptable food processing attachments for the processing of food.

### RELATED APPLICATIONS

This Continuation-In-Part Application claims the benefit of Non-Provisional application Ser. No. 09/659,236, filed Sep. 9, 2000, which claims the benefit of Provisional Application Serial No. 60/153,555, filed on Sep. 13, 1999.

### TECHNICAL FIELD

The present invention relates generally to kitchen accessories and, more specifically, to a food washing device capable of washing and/or processing fruits and vegetables and means therefor. The present invention is particularly useful in, although not strictly limited to, kitchen applications where it is desired to provide hands-free, time-controlled washing and/or processing of fruits and/or vegetables.

### BACKGROUND OF THE INVENTION

It is well known that almost all dietary guidelines recommend high consumption of fruits and vegetables. Benefits touted include decreased cholesterol, decreased risk of heart disease, decreased risk of cancer, and increased energy. Frozen and canned fruits and vegetables provide nutritional benefits and offer long-term storage. It remains undisputed, however, that fresh fruits and vegetables supply beneficial nutrients that are frequently lost in canned and processed foods. As a result, it is recommended that dietary requirements be satisfied with fresh fruits and vegetables as often as possible.

Prior to the consumption, preparation and/or processing of fresh foods, however, effective cleansing is essential. The benefits derived from natural antioxidants, vitamins, and fiber can otherwise be negated due to the potential presence of pesticides, fertilizers, and bacteria. Some pesticides have been linked to increased risks of cancer. Improper washing can even result in death, such as with ingestion of E-coli bacterial contamination.

A direct result of consumer awareness regarding dietary guidelines and the necessity of food cleansing is reflected in the new generation of food washing products. A few attempts have been made to design a suitable cleanser or device for washing fresh fruits and vegetables. However, in view of the present invention, these cleansers and devices are disadvantageous.

For instance, one such cleanser is a soapy type liquid concentrate into which fruits and vegetables can be immersed. Alternatively, the soapy type liquid can be sprayed directly onto the food. Disadvantages of this type of cleanser includes: the time involved in applying the cleanser; the task of effectively distributing it over the produce to be cleaned; and the chore of rinsing and removing the residual cleanser from the food prior to consumption. Not only is the process time consuming, but effective washing and removal of the cleansing product itself is often difficult.

Another alternative incorporates a plastic bowl and strainer in combination. Fruits and vegetables to be washed may be immersed within the strainer and bowl, with the strainer handle manually rotated for a pseudo-agitation. This device is disadvantageous because it, too, requires a lengthy hands-on approach.

Therefore, it is readily apparent that there is a need for a food washing and processing device wherein hands-free, time-controlled, automatic and effective cleansing of fruits and vegetables is provided, and wherein the device provides a plurality of food processing and/or preparation mechanisms. It is therefore to such an improvement that the present invention is directed.

### BRIEF SUMMARY OF THE INVENTION

Briefly described, in a preferred embodiment, the present invention overcomes the above-mentioned disadvantages, and meets the recognized need for such a device, by providing a food washing and processing device wherein fresh fruits and vegetables are automatically agitated and cleansed, and wherein such fruits and vegetables may subsequently be processed via a plurality of food processing attachments.

According to its major aspects and broadly stated, the present invention is a food washing and processing appliance having a fluid dispensing reservoir, a removable basket, a motor-driven agitator, a timer, and a plurality of food processing attachments.

More specifically, the present invention is an electrically operated food washing and processing appliance having a fluid reservoir wherein washing fluid can be held and subsequently introduced into a washing compartment having an agitator and removable food basket. Both compartments are provided with hinged lids, thereby allowing complete access. A drain having a retractable hose is attached to the washing compartment to allow for the controlled release of dirty washing fluid.

The appliance includes a space-saving retractable power cord and has electrical controls for length and intensity of wash cycle. Wash intensity is a function of agitator motion and may be observed through a compartment window. The motor-driven agitator includes a plurality of apertures, wherein wash fluid is disbursed therefrom onto the food in the basket within the washing compartment and, thereby, loosening particulate matter and residue adhered thereto. The food basket functions to contain the food within the washing compartment and to protect the food from direct contact with the agitator. Dirt, foreign residue, and residual insecticides and pesticides are removed by the swirling action of the wash fluid and the subsequent release of soiled wash fluid therefrom.

Following effective cleansing of the produce within the basket, and subsequent removal of the basket and produce from the washing compartment, a plurality of food processing attachments may be engaged with the agitator for processing of the cleansed produce.

Thus, an object, feature, and advantage of the present invention is to provide a food washing and processing appliance that is simple to use.

Another object, feature, and advantage of the present invention is to provide a food washing and processing appliance enabling the hands-free washing and/or processing of fruits and vegetables.

Still another object, feature, and advantage of the present invention is to provide a food washing and processing appliance having a motor-driven agitator to distribute and swirl wash fluid.

Yet still another object, feature, and advantage of the present invention is to provide a food washing and processing appliance having a retractable drain hose to allow for the controlled release of soiled wash fluid.

A further object, feature, and advantage of the present invention is to provide a food washing and processing appliance having automatic washing cycles wherein the length and intensity of each cycle is electrically controlled.

These and other objects, features, and advantages of the present invention will become more apparent to one ordinarily skilled in the art from a review of the following Detailed Description and Claims when read in light of the accompanying drawing Figure.

### BRIEF DESCRIPTION OF THE DRAWINGS

The present invention will be better understood by reading the Detailed Description of the Preferred and Alternate Embodiments with reference to the accompanying drawing Figure, in which like reference numerals denote similar structure and refer to like elements throughout, and in which:

FIG. 1 is a perspective view of a food washing and processing device according to a preferred embodiment of the present invention showing a basket and a plurality of food processing attachments removed from a wash compartment.

FIG. 2 is a perspective view of a food washing and processing device according to an alternate embodiment of the present invention showing a basket removed from a wash compartment.

FIG. 3 is a perspective view of a food washing and processing device according to an alternate embodiment of the present invention showing a plurality of food processing attachments.

### DETAILED DESCRIPTION OF THE PREFERRED AND ALTERNATE EMBODIMENTS

In describing the preferred and alternate embodiments of the present invention, as illustrated in the Figure, specific terminology is employed for the sake of clarity. The invention, however, is not intended to be limited to the specific terminology so selected, and it is to be understood that each specific element includes all technical equivalents that operate in a similar manner to accomplish similar functions.

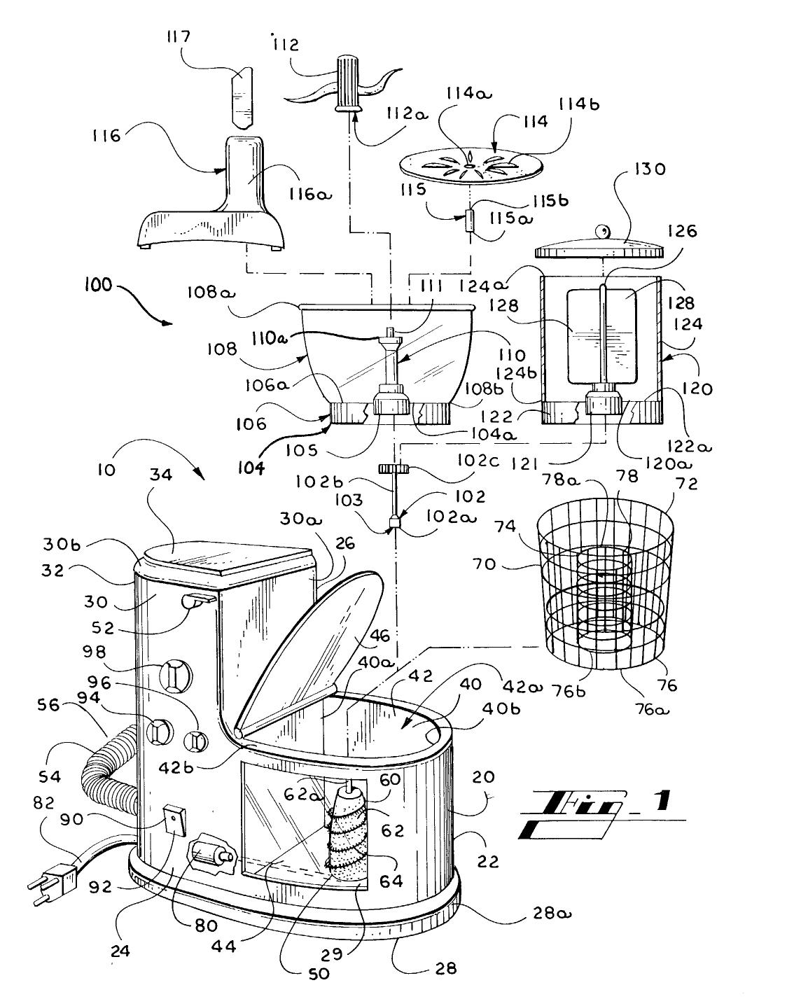

Referring now to FIG. 1, the present invention is a food washing and processing device 10 having housing 20, fluid dispensing means in the form of reservoir 30, wash compartment 40, agitator 60, basket 70, motor 80, controls 90-98, and food processing assembly 100.

Housing 20 has outer surface 22 preferably manufactured from plastic and preferably substantially opaque. However, one skilled in the art will recognize that although plastic is the preferred material, housing 20 could be manufactured from, for exemplary purposes only, stainless steel, other various metals or glass. Housing 20 has a front surface 24, a rear surface 26 and a base 28. Preferably, base 28 is substantially oval shaped, extending outwardly from outer surface 22; thereby, providing a supportive edge 28a. Housing 20 defines fluid reservoir 30 and wash compartment 40, wherein fluid reservoir 30 and wash compartment 40 are independent compartments integrally located within housing 20. Housing 20 also defines a substantially transparent viewing window 29 within outer surface 22 of wash compartment 40, allowing a user to see therewithin. Preferably, viewing window 29 is substantially rectangular-shaped.

Fluid reservoir 30 has upper end 32, wherein lid 34 is hingedly attached thereto for ease of accessibility. Preferably, fluid reservoir 30 is approximately twice the height of wash compartment 40 and is located proximal thereto, wherein washing fluid can be introduced into fluid reservoir 30 and held therein for subsequent introduction to wash compartment 40. Fluid reservoir 30 has a substantially flat end wall 30a and a substantially U-shaped end wall 30b. Preferably, fluid reservoir 30 has graduated lines therein to assist the user in determining proper fill capacity of the reservoir.

Preferably, wash compartment 40 has a substantially flat end wall 40a and a substantially U-shaped end wall 40b, wherein flat wall 40a of wash compartment 40 and flat wall 30a of fluid reservoir 30 are formed integrally, and wherein fluid reservoir 30 and wash compartment 40, together, define a substantially oval plane-view shape. Wash compartment 40 has upper end 42 and interior base surface 44. Lid 46 is hingedly attached to upper end 42 of wash compartment 40 for ease of accessibility.

Drain 50 is located within base surface 44 of wash compartment 40. Preferably, drain 50 is mechanically operated via drain lever 52, wherein drain lever 52 is mounted on outer surface 22 of housing 20. Drain hose 54 is coupled to drain 50 to allow for the controlled release of dirty washing fluid upon user depression of drain lever 52 to open drain 50. Preferably, drain hose 54 is retractable and has first end 54a (not shown), second end 54b (not shown) and outer surface 56. First end 54a is securely coupled to drain 50 wherein the attachment provides a watertight seal. Preferably, hook 58 (not shown) is fixedly mounted on rear surface 26 of housing 20, wherein outer surface 56 of drain hose 50 may be secured thereon when not in use.

Preferably, agitator 60 is centrally mounted within wash compartment 40. Agitator 60 is generally cylindrically shaped and is movably secured on a central axis 62. Agitator 60 is preferably motor-driven and operates rotationally about axis 62. One skilled in the art will recognize that although rotational movement is preferred, longitudinal movement could also be provided. It should also be noted that in lieu of a motor-driven agitator, a hand crank or pump may be utilized to rotate or manipulate agitator 60. Operational movement of agitator 60 results in movement of wash fluid within wash compartment 40; thus, wash intensity is a function of agitator motion. Agitator 60 has outer surface 62 with a plurality of apertures 64 provided therein. Preferably, apertures 64 are aligned to create a continuous pattern encircling agitator 60, whereby wash fluid is dispensed therethrough at a plurality of heights and locations. One skilled in the art will recognize that alternate aperture designs and locations may be utilized to provide equivalent methods of dispensing wash fluid.

Basket 70 for retaining food items is removably secured within wash compartment 40. Preferably, basket 70 is wire mesh. Basket 70 is generally cylindrically shaped with outer wall 72, inner wall 74, and base wall 76. Inner wall 74 defines a central cavity 78 with top wall 78a. Base wall 76 is generally circular with outer edge 76a adjacent to outer wall 74, and inner edge 76b adjacent to inner wall 74. Central cavity 78 is dimensioned to surround agitator 60 such that central cavity 78 is not in contact with agitator 60, but, rather, prevents food items from contact therewith.

Motor 80 preferably is located within housing 20, beneath wash compartment 40, and functions to provide power to agitator 60. Standard household power is provided to motor 80 with a standard electrical cord 82 connected thereto. Preferably, electrical cord 82 is retractable to allow for compact storage thereof.

A plurality of electrical controls 90-98 are engaged on front surface 24 of housing 20. Preferably, the electrical controls include on-off switch 92, regular cycle selector knob 94, gentle cycle selector knob 96, and timer 98. Regular cycle selector knob 94 and gentle cycle selector knob 96 function to control the action of agitator 60 and, thereby, allow a user to choose wash intensity based upon the type of fruit or vegetable to be washed. Timer 98 functions to control the length of the wash cycle. Preferably, variable time periods may be selected up to a maximum of about fifteen minutes.

Following the effective cleansing of produce within wash compartment 40, and upon removal of basket 70 and the cleansed produce therefrom, food processing assembly 100 may be engaged with agitator 60 to enable processing of the cleansed produce. Specifically, food processing assembly 100 preferably possesses gear adaptor 102, food processing unit 104 and ice cream maker 120.

Gear adaptor 102 preferably possesses socket 102a in communication with upwardly extending shaft 102b, wherein shaft 102b terminates in substantially circular-shaped toothed gear 102c. Preferably, socket 102a possesses polygonal-shaped inner cavity 103, wherein inner cavity 103 is dimensioned to be securely adapted to end 62a of central axis 62 of agitator 60 via frictional assistance from the polygonal shape of inner cavity 103, thus enabling rotational movement of gear adaptor 102 via activation of motor 80. Shaft 102b preferably possesses a length such that upon adapting socket 102a to end 62a of central axis 62, gear 102c preferably sits just above aperture 42a of upper end 42 of wash compartment 40.

Preferably, the toothed configuration of gear 102c enables gear 102c to securely interlock with toothed-shaped receiver 105 of food processing unit 104, wherein receiver 105 is formed on undersurface 104a of food processing unit 104, and further preferably possesses rotational capabilities via known bearing mechanisms and/or the like. Food processing unit 104 is preferably substantially similar in form to conventional food processing units, possessing circular-shaped base member 106, bowl 108 extending upwardly from base member 106, rotary shaft 110 extending upwardly from top surface of 106a of base 106, S-blade 112, slicing/shredding disk 114, and cover 116.

Preferably, rotary shaft 110 is in rotatable communication with receiver 105, such that upon attachment of gear adaptor 102 to receiver 105, and upon activation of motor 80, rotary shaft 110 is rotated accordingly. Rotary shaft 110 is preferably dimensioned to securely and removably receive S-blade 112 upon engaging S-blade 112 thereto via socket 112a formed in S-blade 112, wherein S-blade preferably functions to cut food introduced into bowl 108. Additionally, semi-circular-shaped protuberance 111 extending from end 110a of shaft 110 is preferably dimensioned to securely removably receive substantially dowel-shaped adaptor 115 via semi-circular-shaped channel 115a formed through adaptor 115, wherein adaptor 115 further preferably possesses semi-circular-shaped end 115b dimensioned to securely slidably engage semi-circular-shaped throughhole 114a centrally formed through slicing/shredding disk 114 for adaptation of slicing/shredding disk 114 thereto following removal of S-blade 112 from rotary shaft 110. Preferably, slicing/shredding disk 114 possesses a plurality of slicing/shredding surfaces 114b as known within the art of food processing units. Cover 116 is preferably dimensioned to securely interlock with upper portion 108a of bowl 108 as known within the art, wherein cover 116 further possesses chute 116a formed thereon for the introduction of food therethrough for subsequent processing via S-blade 112 and/or slicing/shredding disk 114, and wherein a food pusher 117 is further provided to assist in the pushing of food through chute 116. It is contemplated in an alternate embodiment that other types and/or forms of food processing units could be utilized, possessing different components and/or cutting mechanisms that could be functionally adapted to agitator 60 for subsequent operation via motor 80.

Preferably, upon placement of food processing unit 104 onto wash compartment 40, and upon engaging gear adapter 102 therewith, base 106 is removably secured within aperture 42a of wash compartment 40, and further stabilized therein and thereon via the support of lower region 108b of bowl 108 on upper peripheral lip 42b of wash compartment 40.

Ice cream maker 120 functions preferably in a substantially similar fashion to food processing unit 104. Preferably, the toothed configuration of gear 102c enables gear 102c to securely interlock with toothed-shaped receiver 121 of ice cream maker 120, wherein receiver 121 is formed on undersurface 120a of ice cream maker 120, and further preferably possesses rotational capabilities via known bearing mechanisms and/or the like. Ice cream maker 120 is preferably substantially similar in form to conventional ice cream makers, possessing circular-shaped base member 122, canister 124 extending upwardly from base member 122, rotary spindle 126 extending upwardly from top surface of 122a of base 122, paddles 128 formed on rotary spindle 128, and lid 130 dimensioned to be removably secured to upper region 124a of canister 124, wherein paddles 128 preferably function to turn the ice cream ingredients within canister 124 as known within the art. It is contemplated in an alternate embodiment that other types and/or forms of ice cream makers could be utilized, possessing different components and/or creamery mechanisms that could be functionally adapted to agitator 60 for subsequent operation via motor 80.

Preferably, rotary spindle 128 is in rotatable communication with receiver 121, such that upon attachment of gear adaptor 102 to receiver 121, and upon activation of motor 80, rotary spindle 128 is rotated accordingly. Preferably, upon placement of ice cream maker 120 onto wash compartment 40, and upon engaging gear adapter 102 therewith, base 122 is removably secured within aperture 42a of wash compartment 40, and further stabilized therein and thereon via the support of lower region 124b of canister 124 on upper peripheral lip 42b of wash compartment 40.

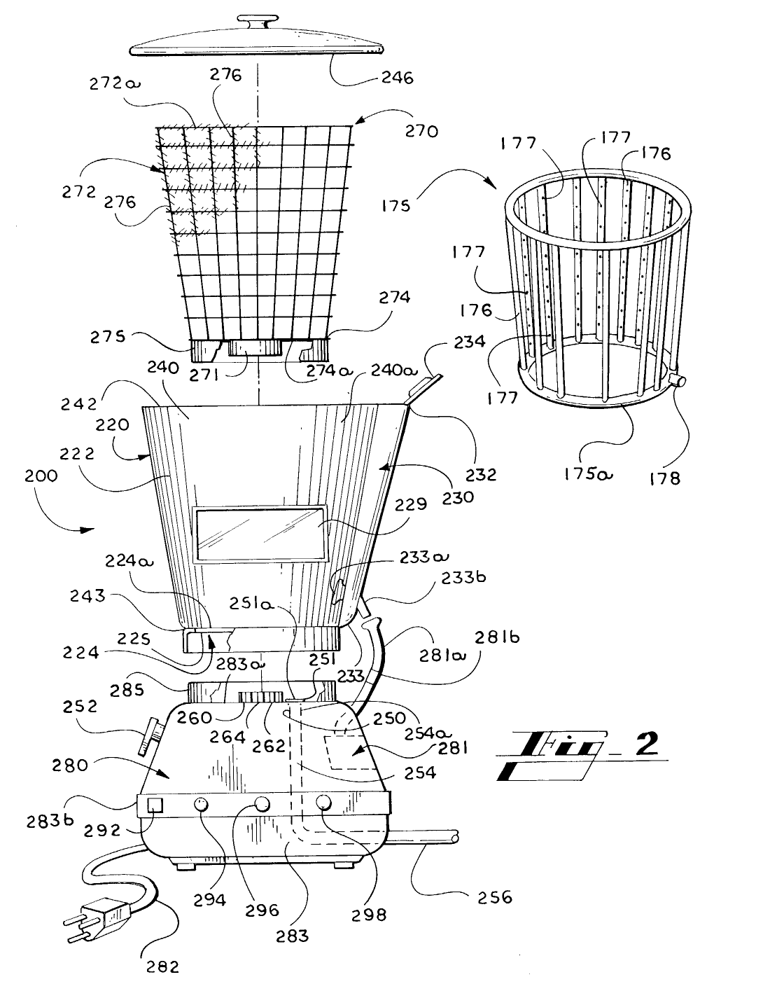

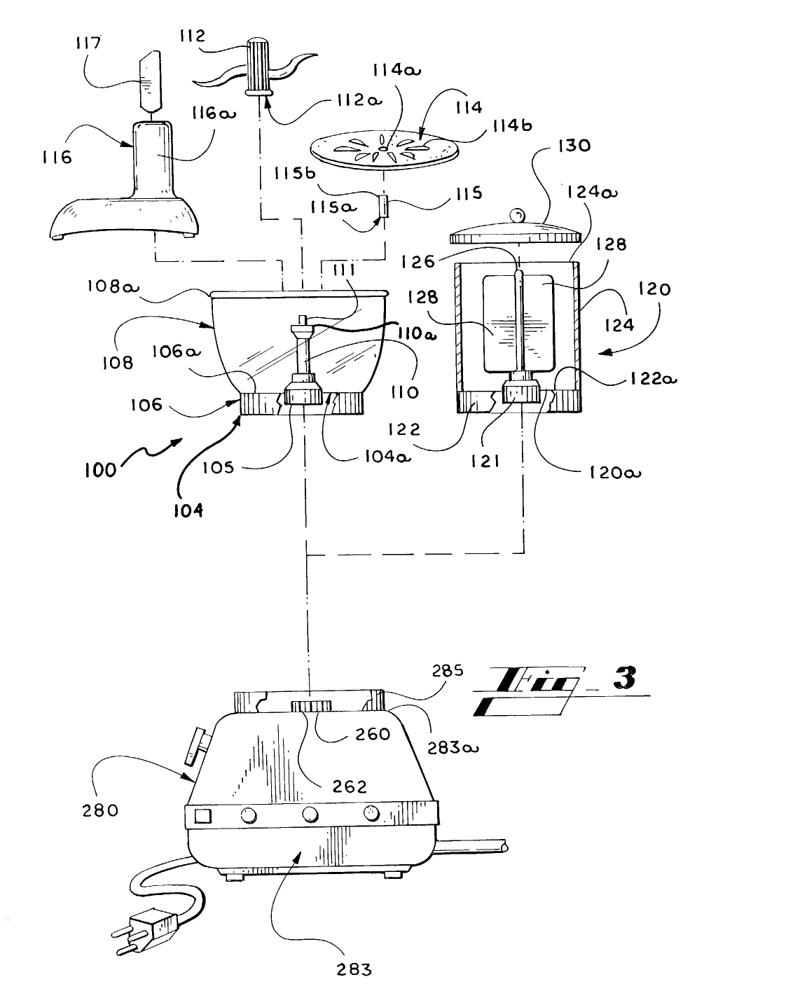

Referring now to FIGS. 2-3, illustrated therein is food washing and processing device 200 according to an alternate embodiment of the present invention, having housing 220, fluid dispensing means in the form of reservoir 230, wash compartment 240, agitator 260, basket 270, tubular lattice 275, motor 280, controls 290-298, and food processing assembly 100.

Referring now more specifically to FIG. 2, housing 220 has outer surface 222 preferably manufactured from plastic and preferably substantially opaque. However, housing 220 could be manufactured from other suitable material such as, for exemplary purposes only, stainless steel, and/or other various metals or glass. Housing 220 further possesses substantially circular-shaped base aperture 224, wherein inner peripheral edge 224a of base aperture 224 possesses water seal 225 extending therearound for creating a watertight seal with motor 280 when engaged therewith, as more fully described below.

Housing 220 defines fluid reservoir 230 and wash compartment 240, wherein fluid reservoir 230 and wash compartment 240 are independent compartments integrally located within housing 220. Housing 220 also defines a substantially transparent viewing window 229 formed within outer surface 222 of wash compartment 240, allowing a user to see therewithin. Viewing window 229 is substantially rectangular-shaped; although, window 229 could define any other suitable shape.

Fluid reservoir 230 has upper end 232, wherein lid 234 is hingedly attached thereto for ease of accessibility. Fluid reservoir 230 has graduated lines therein to assist the user in determining proper fill capacity of fluid reservoir 230. Furthermore, fluid reservoir 230 is substantially equivalent in height to wash compartment 240 and is located proximal thereto, wherein washing fluid can be introduced into fluid reservoir 230 and held therein for subsequent introduction into wash compartment 240 via tubular lattice 275. Specifically, lower end 233 of fluid reservoir 230 is substantially closed off, possessing interior spout 233a and exterior spout 233b, wherein interior spout 233a extends into wash compartment 240, and wherein exterior spout 233b extends outwardly from fluid reservoir 230 and is in communication with pump line 281a of water pump 281 housed within motor housing 283. Water pump 281 is any suitable conventional water pump known within the art, wherein water pump 281 functions to pump wash fluid from fluid reservoir 230 through interior spout 233a for circulation through tubular lattice 175, as more fully described below. It is contemplated in an alternate embodiment that water pump 281 could function to pump air into fluid reservoir 230, thus creating a pressure differential therein, causing water to forcefully exit through interior spout 233a for circulation through tubular lattice 175. Pump line 281a possesses a back-flow prevention valve 281b that prevents the backflow of water therethrough, thus avoiding water damage to pump 281.

Tubular lattice 175 is a baseless, basket-shaped lattice of tubes 176, wherein each of tubes 176 possesses a plurality of aligned throughholes 177 formed therethrough. Tubular lattice 175 is dimensioned to be received by wash compartment 240 and sit substantially flush against inner surface 240a of wash compartment 240 so as to not interfere with the rotational movement of basket 270 therein, as more fully described below. Extending from lower end 175a of tubular lattice 175 is spout attachment 178, wherein spout attachment 178 can be securely engaged with interior spout 233a of fluid reservoir 230. As such, water forcefully exiting from interior spout 233a via pump action from water pump 281, will be channeled through attached tubular lattice 175 and jettfully sprayed therefrom via plurality of throughholes 177 of tubes 176, thus permitting the washing of produce within basket 270 when placed within wash compartment 240, as more fully described below.

Wash compartment 240 has upper end 242 and lower end 243, wherein lower end 243 defines base aperture 224 of housing 220. As previously described, base aperture 224a possesses water seal 225 formed around the entirety of inner peripheral edge 224a of base aperture 224. Base aperture is dimensioned to be removable secured over collar 285 centrally formed on upper surface 283a of motor housing 283, creating a watertight seal therewith via water seal 225, thus preventing leakage of water and/or washing fluid from wash compartment 240. Lid 246 is removably attachable to upper end 242 of wash compartment 240 for ease of accessibility.

Extending centrally from upper surface 283a of motor housing 283 is agitator 260, wherein agitator 260 is a generally toothed gear 262 rotatably operated via motor 280 housed within motor housing 283, beneath wash compartment 240. Standard household power is provided to motor 280 and pump 281 via a standard electrical cord 282 connected thereto, wherein electrical cord 282 is retractable to allow for compact storage thereof. A water seal/gasket 264 is disposed directly beneath gear 262 so as to prohibit introduction of water/wash fluid into motor housing 283, thus preventing damage to motor 280 and pump 281 housed therein. Gear 262 is dimensioned to be received by receiver 271 of basket 270 to permit rotational movement of basket 270 within wash compartment 240, as more fully described below.

A plurality of electrical controls 290-298 are engaged on front surface 283b of motor housing 283. The electrical controls include on-off switch 292, regular cycle selector knob 294, gentle cycle selector knob 296, and timer 298. Regular cycle selector knob 294 and gentle cycle selector knob 296 function to control the action of agitator 260 and, thereby, allow a user to choose wash intensity based upon the type of fruit or vegetable to be washed. Timer 298 functions to control the length of the wash cycle.

Drain 250 is located on upper surface 283a of motor housing 283, within collar 285, wherein drain 250 is an aperture 251 having a water seal/gasket 251a formed therearound so as to prohibit introduction of water/wash fluid into motor housing 283, thus preventing damage to motor 280 and pump 281 housed therein. Drain 250 is mechanically operated via drain lever 252, wherein drain lever 252 is mounted on motor housing 283. Drain hose 254 is coupled to aperture 251 of drain 250 to allow for the controlled release of dirty washing fluid upon user depression of drain lever 252 to open drain 250. Drain hose 254 is retractable and has first end 254a, second end 254b (not shown) and outer surface 256. Specifically, first end 254a is securely coupled to aperture 251 of drain 250, wherein the attachment provides a watertight seal. Hook 258 (not shown) is fixedly mounted to motor housing 283, wherein outer surface 256 of drain hose 250 may be secured thereon when not in use.

Basket 270 for retaining food items is removably secured within wash compartment 240. Specifically, basket 270 is generally cylindrically-shaped, having mesh wall 272, and mesh base 274, wherein inner surface 272a of mesh wall 272 may possess a plurality of aligned soft bristles 276 for the gentle scrubbing of produce washed therein, and wherein the mesh configuration of mesh base 274 permits draining of wash fluid therethrough for drainage via drain 250. Basket 270 is formed from a durable plastic mesh material to give basket 270 structural form; however, other suitable material could be utilized, such as, for exemplary purposes only, metal mesh.

Receiver 271 is fixedly attached to undersurface 274a of mesh base 274, and possesses a toothed-shape to permit the secured interlocking communication with toothed gear 262 of agitator 260, thus enabling rotational movement thereof within wash compartment 240. Secured to mesh base 274 is collar 275, wherein collar 275 is dimensioned to freely swivel within collar 285 of motor housing 283, and further functions to supportively elevate basket 270 an appropriate distance from upper surface 283a of motor housing 283.

Referring now to FIG. 3, following the effective cleansing of produce within wash compartment 240, and upon removal of basket 270 and the cleansed produce therefrom, food processing assembly 100 may be engaged with agitator 260 to enable processing of the cleansed produce. Specifically, food processing assembly 100 possesses food processing unit 104 and ice cream maker 120.

The toothed configuration of gear 262 of agitator 260 enables gear 262 to securely interlock with toothed-shaped receiver 105 of food processing unit 104, wherein receiver 105 is formed on undersurface 104a of food processing unit 104, and further possesses rotational capabilities via known bearing mechanisms and/or the like. Food processing unit is 104 is substantially similar in form to conventional food processing units, possessing circular-shaped base member 106, bowl 108 extending upwardly from base member 106, rotary shaft 110 extending upwardly from top surface of 106a of base 106, S-blade 112, slicing/shredding disk 114, and cover 116.

Rotary shaft 110 is in rotatable communication with receiver 105, such that upon attachment of gear 262 to receiver 105, and upon activation of motor 280, rotary shaft 110 is rotated accordingly. Rotary shaft 110 is dimensioned to securely and removably receive S-blade 112 upon engaging S-blade 112 thereto via socket 112a formed in S-blade 112, wherein S-blade functions to cut food introduced into bowl 108. Additionally, semi-circular-shaped protuberance 111 extending from end 110a of shaft 110 is dimensioned to securely removably receive substantially dowel-shaped adaptor 115 via semi-circular-shaped channel 115a formed through adaptor 115, wherein adaptor 115 further possesses semi-circular-shaped end 115b dimensioned to securely slidably engage semi-circular-shaped throughhole 114a centrally formed through slicing/shredding disk 114 for adaptation of slicing/shredding disk 114 thereto following removal of S-blade 112 from rotary shaft 110. Slicing/shredding disk 114 possesses a plurality of slicing/shredding surfaces 114b as known within the art of food processing units. Cover 116 is dimensioned to securely interlock with upper portion 108a of bowl 108 as known within the art, wherein cover 116 further possesses chute 116a formed thereon for the introduction of food therethrough for subsequent processing via S-blade 112 and/or slicing/shredding disk 114, and wherein a food pusher 117 is further provided to assist in the pushing of food through chute 116. It is contemplated in an alternate embodiment that other types and/or forms of food processing units could be utilized, possessing different components and/or cutting mechanisms that could be functionally adapted to agitator 260 for subsequent operation via motor 280.

Upon placement of food processing unit 104 onto wash compartment 240, and upon engaging gear 262 therewith, base 106 is removably secured around collar 285 of motor housing 283, and stabilized thereagainst and thereon.

Ice cream maker 120 functions in a substantially similar fashion to food processing unit 104. The toothed configuration of gear 262 of agitator 260 enables gear 262 to securely interlock with toothed-shaped receiver 121 of ice cream maker 120, wherein receiver 121 is formed on undersurface 120a of ice cream maker 120, and further possesses rotational capabilities via known bearing mechanisms and/or the like. Ice cream maker 120 is substantially similar in form to conventional ice cream makers, possessing circular-shaped base member 122, canister 124 extending upwardly from base member 122, rotary spindle 126 extending upwardly from top surface of 122a of base 122, paddles 128 formed on rotary spindle 128, and lid 130 dimensioned to be removably secured to upper region 124a of canister 124, wherein paddles 128 function to turn the ice cream ingredients within canister 124 as known within the art. It is contemplated in an alternate embodiment that other types and/or forms of ice cream makers could be utilized, possessing different components and/or creamery mechanisms that could be functionally adapted to agitator 60 for subsequent operation via motor 80.

Rotary spindle 128 is in rotatable communication with receiver 121, such that upon attachment of gear 262 to receiver 121, and upon activation of motor 280, rotary spindle 128 is rotated accordingly. Upon placement of ice cream maker 120 onto wash compartment 240, and upon engaging gear 262 therewith, base 122 is removably secured around collar 285 of motor housing 283, and stabilized thereagainst and thereon.

Although the exemplary embodiment of the present invention has been described above in detail, one ordinarily skilled in the art will appreciate that various modifications, variations, and alternate embodiments may be provided to enhance, vary, and provide additional consumer benefits to the invention. Exemplary alternate embodiments are provided below. For example:

In an alternate embodiment, base 28 of housing 20 could define a different shape, such as, for exemplary purposes only, a rectangle, square, or diamond.

In an alternate embodiment, outer surface 22 of base 28 of housing 20 could have elastomeric feet to assist in secure positioning.

In another alternate embodiment, central cavity 78 could be substantially cone shaped.

In yet another alternate embodiment, viewing window 29 could be a different shape, such as, for exemplary purposes only, circular, oval, or square, and might follow the contour of outer surface 22.

In still yet another alternate embodiment, food washing device could be formed without a viewing window.

In yet still another alternate embodiment, the height of fluid reservoir 30 could be substantially the same as the height of wash compartment 40.

In still another alternate embodiment, the apertures 64 in agitator 60 could be arranged in concentric circles surrounding agitator 60, in longitudinal lines along the length of agitator 60, or randomly disbursed or patterned to substantially cover agitator 60. Similarly, apertures 64 might be located at different positions within wash compartment 40 and might be provided with jet-like nozzles.

In yet another alternate embodiment, basket 70 could be another shape, such as, for exemplary purposes only, square or oval.

In yet still another alternate embodiment, basket 70 could have a handle.

In still another alternate embodiment, basket 70 could be plastic or any other suitable material.

In yet another alternate embodiment, food washing device 10 could be manufactured in appropriately larger-scaled forms for commercial use.

In yet still another embodiment, the fluid reservoir 30 might comprise another form of fluid dispensing means, as by direct connection to a clean water line with a nozzle or other similar arrangement for directing clean water into washing compartment 40.

In an alternate embodiment, the food washing device 10 could include a cleanser receptacle and dispensing means.

In another alternate embodiment, wash compartment 40 could include a light.

In yet another alternate embodiment, wash compartment 40 could include more than one agitator.

In still another alternate embodiment, basket 70 could be engaged on an axis and could be driven to rotate.

In yet still another alternate embodiment, fluid reservoir 30 could have a removable insert for transporting fluid.

In yet another alternate embodiment, timer 98 could include an audible indicator.

In still another alternate embodiment, fluid reservoir 30 and wash compartment 40 could be one combined compartment wherein fluid is added by the user directly into the wash compartment.

In yet still another alternate embodiment, fluid reservoir 30 could be provided with a sight glass, or other fluid level fill indicator, to assist the user in determining proper fill capacity of the reservoir.

In yet still another alternate embodiment, device 200 could be modified such that agitator 260 is substantially similar to agitator 60 of device 10, thus permitting water/washing fluid to be sprayed therefrom, wherein inner surface 240a of wash compartment 240 could be sufficiently textured to permit the simultaneous washing and peeling of certain vegetables and/or fruit therein upon removal of basket 270 therefrom.

Having now described the preferred and alternate embodiments of the device of the present invention, we turn to the preferred manner of use of the device. Accordingly, in use, vegetables or fruit are placed into basket 70 and lid 46 is opened. Basket 70 is placed inside wash compartment 40 with central cavity 78 of basket 70 surrounding agitator 60. After closing lid 46 of wash compartment 40, lid 34 of fluid reservoir 30 is opened and fluid reservoir 30 is filled with water, and lid 34 is then closed. Cycle length and intensity are selected by turning the appropriate control knob 94 or 96, and 98. The food washing device 10 is started by depressing the on-off switch 92.

The user then enjoys the benefit of being able to perform other tasks in the kitchen while the device 10 automatically introduces fluid from fluid reservoir 30 through the apertures 64 in agitator 60, and into wash compartment 40; thereby, loosening dirt particles on the food items as wash compartment 40 fills with fluid. Once wash compartment 40 is filled, agitator 60 begins rotational movement, causing the fluid in the wash compartment 40 to swirl around the food items; thereby, cleaning those items. The front-mounted viewing window 29 allows the user to observe the washing cycle. When the programmed time has expired, agitation ceases, and the cleaned food is removed by pulling basket 70 out of wash compartment 40. The soiled water is drained into a sink or other receptacle by appropriately situating retractable hose 54 and pushing down drain lever 52.

Having thus described the exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A food preparation device comprising:
means for washing food, wherein said means for washing food is adapted to accept means for processing food.

2. The food preparation device of claim 1, wherein said means for washing food comprises a housing, said housing defining at least one washing compartment and at least one fluid reservoir for dispensing wash fluid into said at least one washing compartment.

3. The food preparation device of claim 2, wherein said at least one washing compartment carries at least one agitator for scrubbing food placed within said at least one washing compartment, said at least one agitator mechanically coupled to an electric motor to drive said agitator.

4. The food preparation device of claim 3, wherein said at least one agitator further comprises a plurality of apertures whereby fluid is disbursed therefrom, and wherein said at least one agitator is movably secured on a central axis within said at least one washing compartment.

5. The food preparation device of claim 3, wherein said at least one washing compartment is adapted to receive a food receptacle for containing food, said food receptacle adapted to engage said at least one agitator and move rotationally therewith.

6. The food preparation device of claim 2, wherein said at least one washing compartment is adapted to receive a tubular lattice having a plurality of throughholes, said tubular lattice adapted to communicate with said at least one fluid reservoir for pumping said wash fluid therefrom and spraying said wash fluid over food placed within said at least one washing compartment.

7. The food preparation device of claim 1, further comprising means for draining fluid from said at least one washing compartment

8. The food preparation device of claim 6, wherein said means for draining comprises at least one drain formed in said at least one washing compartment and coupled to at least one drain hose, and wherein said means for draining further comprises means for activating said drain.

9. The food preparation device of claim 8, wherein said activation means comprises a control movable between a first closed-drain position and a second open-drain position.

10. The food preparation device of claim 1, wherein said means for processing food is a food processing unit comprising a rotatable shaft.

11. The food preparation device of claim 10, wherein said rotatable shaft of said food processing unit is rotationally adapted to said central axis of said at least one wash compartment via an adapter extending from said central axis to said rotatable shaft.

12. The food preparation device of claim 10, wherein said rotatable shaft of said food processing unit is rotationally engagable with said at least one agitator.

13. The food preparation device of claim 10, wherein said rotatable shaft of said food processing unit is adapted to accept at least one food cutting blade.

14. The food preparation device of claim 10, wherein said rotatable shaft of said food processing unit is adapted to accept at least one food processing disk.

15. The food preparation device of claim 1, wherein said means for processing food is an ice cream maker comprising a rotatable shaft.

16. The food preparation device of claim 15, wherein said rotatable shaft of said ice cream maker is rotationally adapted to said central axis of said at least one wash compartment via an adapter extending from said central axis to said rotatable shaft.

17. The food preparation device of claim 15, wherein said rotatable shaft of said ice cream maker is rotationally engagable with said at least one agitator.

18. A food preparation device comprising:
means for washing food, wherein said means for washing food is adapted to accept means for processing food; and,
means for draining wash fluid from said means for washing food.

19. The food preparation device of claim 18, wherein said means for washing food comprises a housing, said housing defining at least one washing compartment and at least one fluid reservoir for dispensing wash fluid into said at least one washing compartment.

20. The food preparation device of claim 19, wherein said at least one washing compartment carries at least one agitator for scrubbing food placed within said at least one washing compartment, said at least one agitator mechanically coupled to an electric motor to drive said agitator.

21. The food preparation device of claim 20, wherein said at least one agitator further comprises a plurality of apertures whereby fluid is disbursed therefrom, and wherein said at least one agitator is movably secured on a central axis within said at least one washing compartment.

22. The food preparation device of claim 20, wherein said at least one washing compartment is adapted to receive a food receptacle for containing food, said food receptacle adapted to engage said at least one agitator and move rotationally therewith.

23. The food preparation device of claim 19, wherein said at least one washing compartment is adapted to receive a tubular lattice having a plurality of throughholes, said tubular lattice adapted to communicate with said at least one fluid reservoir for pumping said wash fluid therefrom and spraying said wash fluid over food placed within said at least one washing compartment.

24. The food preparation device of claim 18, wherein said means for draining comprises at least one drain formed in said at least one washing compartment and coupled to at least one drain hose, and wherein said means for draining further comprises means for activating said drain.

25. The food preparation device of claim 24, wherein said activation means comprises a control movable between a first closed-drain position and a second open-drain position.

26. The food preparation device of claim 18, wherein said means for processing food is a food processing unit comprising a rotatable shaft.

27. The food preparation device of claim 26, wherein said rotatable shaft of said food processing unit is rotationally adapted to said central axis of said at least one wash compartment via an adapter extending from said central axis to said rotatable shaft.

28. The food preparation device of claim 26, wherein said rotatable shaft of said food processing unit is rotationally engagable with said at least one agitator.

29. The food preparation device of claim 26, wherein said rotatable shaft of said food processing unit is adapted to accept at least one food cutting blade.

30. The food preparation device of claim 26, wherein said rotatable shaft of said food processing unit is adapted to accept at least one food processing disk.

31. The food preparation device of claim 18, wherein said means for processing food is an ice cream maker comprising a rotatable shaft.

32. The food preparation device of claim 31, wherein said rotatable shaft of said ice cream maker is rotationally adapted to said central axis of said at least one wash compartment via an adapter extending from said central axis to said rotatable shaft.

33. The food preparation device of claim 31, wherein said rotatable shaft of said ice cream maker is rotationally engagable with said at least one agitator.

34. A method of preparing food, comprising the steps of:
a) obtaining a food preparation device, comprising:
at least one washing compartment;
at least one fluid reservoir for dispensing wash fluid into said at least one washing compartment;
at least one agitator powered by a motor; and,
at least one food processing mechanism adaptable to said at least one washing compartment; and
b) placing food to be washed into said at least one washing compartment;
c) transferring fluid from said fluid reservoir into said at least one washing compartment;
d) activating said at least one agitator to agitate said wash fluid and said food within said at least one wash compartment;
e) removing the washed food from said at least one wash compartment; and
f) adapting said at least one food processing mechanism to said at least one washing compartment and processing the food.
